(19) United States
(12) Patent Application Publication
(10) Pub. No.: US 2008/0193141 A1
(43) Pub. Date: Aug. 14, 2008

(54) OPTICAL TRANSMITTER-RECEIVER MODULE

(76) Inventor: Takuya Shinoda, Tokyo (JP)

Correspondence Address: NEC CORPORATION OF AMERICA, 6535 N. STATE HWY 161, IRVING, TX, 75039, US

(21) Appl. No.: 11/863,434

(22) Filed: Sep. 28, 2007

(30) Foreign Application Priority Data
Oct. 2, 2006 (JP) 2006-271016

(51) Int. Cl. H04B 10/00

(52) U.S. Cl. 398/139

(57) ABSTRACT

A small optical transmitter-receiver module capable of regulating the light output level, without changing the mounting position of a laser diode or modifying the laser diode itself, is provided. In the module, a waveguide substrate which forms a planar lightwave circuit, a semiconductor laser element serving as a laser oscillation element which oscillates laser light to be output to the outside transmission path through the planar lightwave circuit, and a photodiode element serving as a light receiving element which receives laser light from the outside transmission path through the planar lightwave circuit, are integrated on a silicon substrate. On an optical waveguide of the planar lightwave circuit, a variable optical attenuator for laser light propagating the optical waveguide is arranged.

This application is based upon and claims the benefit of priority from Japanese patent application No. 2006-271016, filed on Oct. 2, 2006, the disclosure of which is incorporated herein in its entirety by reference.

### BACKGROUND OF THE INVENTION

1. Field of the Invention

The present invention relates to an optical transmitter-receiver module used for optical fiber communications, and in particular, relates to an optical transmitter-receiver module for concentric bi-directional WDM (Wavelength Division Multiplexing).

2. Related Art

As accesses to information such as moving images over the Internet increase in recent years, expansion of the capacity to transmit information is widely demanded even by general users. Along with the demands, the range of applying optical communications expands rapidly not only to backbone systems but also to subscriber systems.

In a bi-directional communication system in which optical signals of different wavelength are transmitted in uploading and downloading, it is necessary to transmit and receive bi-directional communications simultaneously. In view of such grounds and to realize miniaturization and economization, an optical transmitter-receiver module, which uses optical waveguides and in which a transmitting function and a receiving function are integrated, is mainly used as an optical module in an optical subscriber system. Japanese Patent Application Laid-Open NO. 11-68705 (Patent Document 1) discloses such an optical transmitter-receiver module.

The optical transmitter-receiver module in Patent Document 1 is configured such that a laser diode and a photo diode are hybrid-integrated on a planar lightwave circuit and arranged to suppress crosstalk light.

On the other hand, as subscriber systems use optical systems, the optical transmission distance becomes variable, so it is required to regulate the output light level in order to control the transmission distance in an optical transmitter-receiver module. For instance, in a subscriber system, when a laser oscillation element in an optical transmitter-receiver module transmits a signal light of a high level which is beyond necessity, it may affect devices in the optical transmitter-receiver module or may damage equipment of the receiving side, and what is more, the signal light may reach even an unrelated subscriber device to thereby cause the subscriber device to malfunction. In order to prevent such a serious accident, the output light level of an optical transmitter-receiver module is required to be regulated.

However, in such an optical transmitter-receiver module as disclosed in Patent Document 1, it is required to change the mounting position of the Laser diode or to modify the laser diode itself in order to regulate the light output. This leads to an increase in the number of components and the module type is complicated, causing a problem of low production efficiency of the optical transmitter-receiver module or a cost increase.

In order to solve such a problem, Japanese Patent Application Laid-Open NO. 2006-67013 (Patent Document 2) discloses an optical transmission system in which a power regulator is provided in the second stage of the optical transmitter-receiver.

However, if a power regulator or an attenuator is provided in the second stage of an optical transmitter-receiver as described in Patent Document 2, it occupies a space for two devices. Thereby, miniaturization of the optical transmitter-receiver becomes meaningless. Further, even regulating the level of signal light in the second stage of the optical transmitter-receiver, effects on the devices in the optical transmitter-receiver will not be eliminated.

### SUMMARY OF THE INVENTION

In view of the above, it is an exemplary object of the present invention to provide a small optical transmitter-receiver module capable of regulating the light output level without changing the mounting position of a laser diode or modifying the laser diode itself, while improving the inconveniences involved in the related art.

In order to achieve the object, as an exemplary aspect of the invention, an optical transmitter-receiver module of the present invention is configured such that a planar lightwave circuit including optical waveguides, a laser oscillation element which oscillates laser light to be output to an outside transmission path through the planar lightwave circuit, and a light receiving element which receives laser light from the outside transmission path via the planar lightwave circuit, are integrated on a substrate. Further, a light intensity regulating device which regulates the light intensity of laser light propagating an optical waveguide is arranged on the planar lightwave circuit.

According to such an optical transmitter-receiver module, the optical intensity regulating device is formed within the planar lightwave circuit. Therefore, the light output level can be varied without limitation, so the light transmission distance can be varied, without changing the mounting position of the light emitting element or modifying the light emitting element itself which is a conventional method of regulating the light output level. Further, since the size of the optical transmitter-receive module is not changed, miniaturization can be realized.

As an exemplary advantage according to the invention, since the light intensity regulating device (variable optical attenuator) is provided on the planar lightwave circuit (PLC) inside the optical transmitter-receiver module for concentric bi-directional WDM, the light output level can be varied without limitation, so the light transmission distance can be varied, without changing the mounting position of a laser oscillation element or modifying the laser oscillation element itself which is a conventional method of regulating the light output level. Further, since the light intensity regulating device (variable optical attenuator) is provided on the PLC, the size of the optical transmitter-receiver module is not changed, so miniaturization can be realized.

### BRIEF DESCRIPTION OF THE DRAWINGS

FIG. 1 is a perspective view showing the configuration of an optical transmitter-receiver of a first exemplary embodiment according to the present invention;

FIG. 2 is a perspective view showing the configuration of an optical transmitter-receiver module of the first exemplary embodiment disclosed in FIG. 1;

FIG. 3 is a plan view showing the configuration of the optical transmitter-receiver module disclosed in FIG. 2;

FIG. 4 is a perspective view showing the configuration of an optical transmitter-receiver of a second exemplary embodiment according to the present invention; and

FIG. 5 is a plan view showing the configuration of the optical transmitter-receiver nodule of the second exemplary embodiment disclosed in FIG. 4.

### DESCRIPTION OF EXEMPLARY EMBODIMENTS

Hereinafter, exemplary embodiments of the present invention will be described with reference to the drawings.

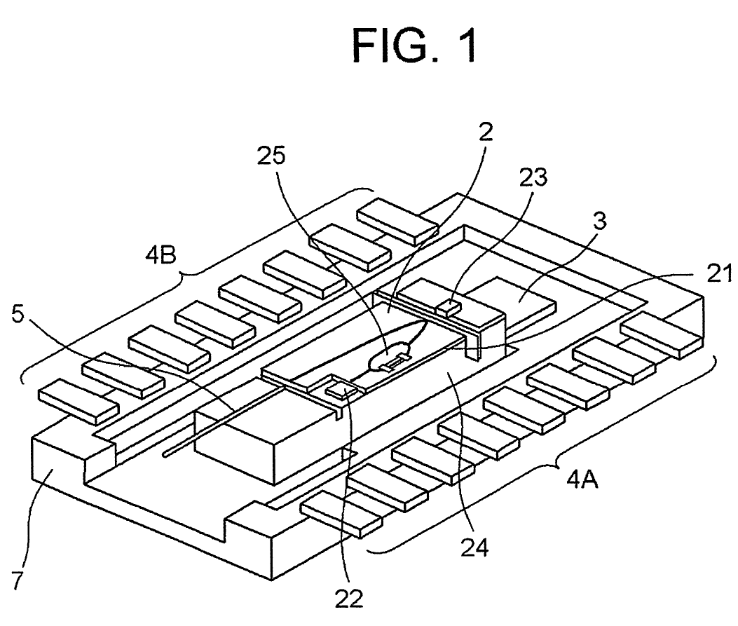

FIG. 1 shows the configuration of an optical transmitter-receiver according to a first exemplary embodiment.

Referring to FIG. 1, the optical transmitter-receiver of the first exemplary embodiment includes an optical transmitter-receiver module 2 and a tranceimpedance amplifier IC 3, inside a ceramic package 7. The optical transmitter-receiver module 2 is configured as a hybrid integrated module in which a semiconductor laser element 22 and a photodiode element 23 are integrated on a silicon substrate 24 including a waveguide substrate 21, laminated thereon, which forms a planar lightwave circuit (unit structure). The transimpedance amplifier IC 3 converts a current output from the photodiode element 23 of the optical transmitter-receiver module 2 into a voltage. The optical transmitter-receiver module 2 is provided with an optical fiber 5.

The ceramic package 7 has a plurality of lead terminals 4A and 4B dividedly provided to the input side and the output side thereof. The lead terminals 4A and 4B are provided for electrically connecting the optical transmitter-receiver modules 2 and the transimpedance amplifier IC 3 inside the ceramic package 7 with a control circuit outside the package 7.

The optical transmitter-receiver module 2 is an optical transmitter-receiver module for concentric bi-directional WDM, in which the waveguide substrate 21 which forms a planar lightwave circuit, the semiconductor laser element 22 serving as a laser oscillation element which oscillates laser light to be output to an outside transmission path through the planar lightwave circuit, and the photodiode element 23 serving as a light receiving element which receives laser light from the outside transmission path through the planar lightwave circuit, are integrated on the silicon substrate 24. On the planar lightwave circuit, a variable optical attenuator 25 is provided as a light intensity regulating device which regulates the light intensity of laser light propagating an optical waveguide.

In the ceramic package 7, some of the lead terminals 4A and 4B connect respective electrodes of the semiconductor laser element 22 and the photodiode element 23 of the optical transmitter-receiver module 2 with the variable optical attenuator 25. This enables to provide electric power from the outside of the package 7 to the semiconductor laser element 22, the photodiode element 23, and the variable optical attenuator 25.

Next, the optical transmitter-receiver module 2 built in the optical transmitter-receiver of the first exemplary embodiment will be described.

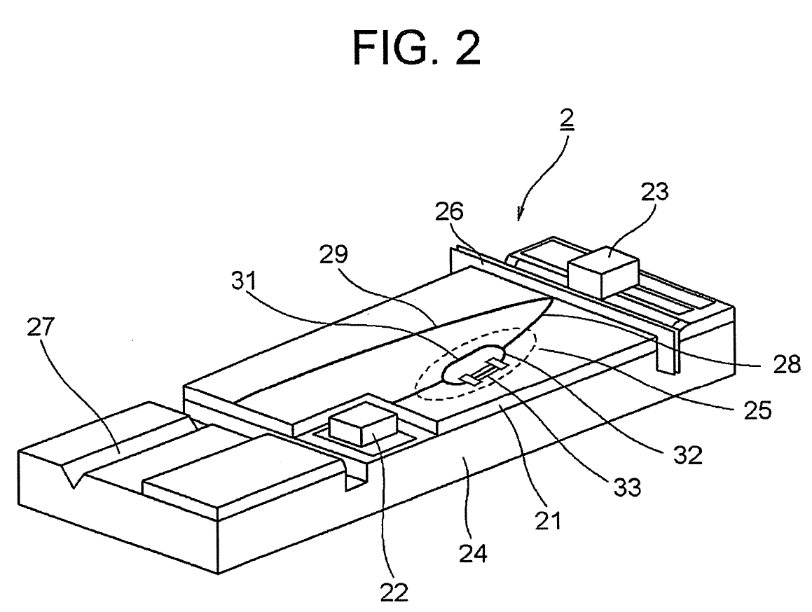

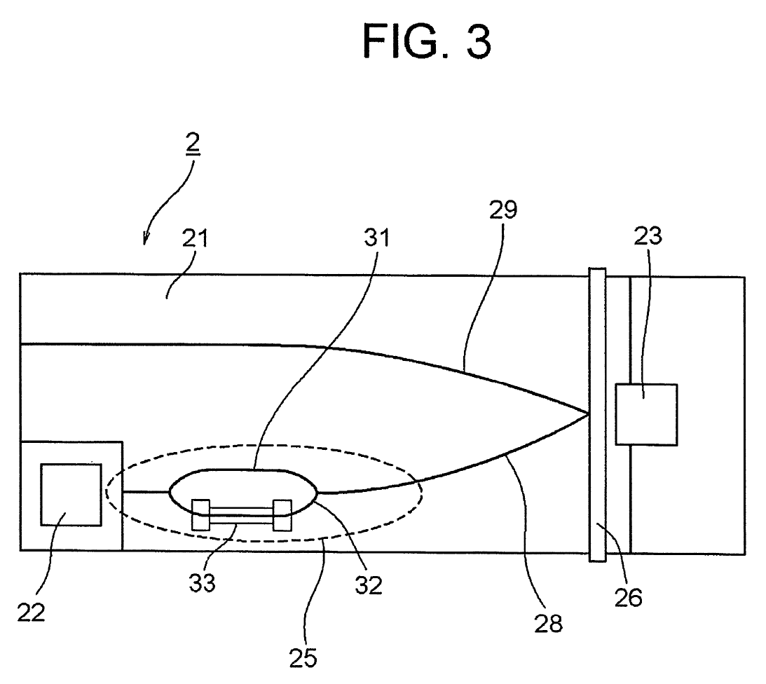

FIG. 2 is a perspective view showing the configuration of the optical transmitter-receiver module 2 of the first exemplary embodiment, and FIG. 3 is a plan view showing the configuration of the optical transmitter-receiver module 2 of the first exemplary embodiment.

The optical transmitter-receiver module 2 of the first exemplary embodiment is configured such that the waveguide substrate 21 which forms the planar lightwave circuit, the semiconductor laser element 22, the photodiode element 23, and a filter 26 which is a dielectric multilayer filter for transmitting or dividing incident light in a reflecting direction corresponding to the wavelength, are integrated on the silicon substrate 24, and a V groove for mounting and fixing the optical fiber 5 leading to the outside transmission path is formed in the silicon substrate 24.

The planar lightwave circuit formed on the waveguide substrate 21 includes a first optical waveguide 28 in which one end links to the light emitting surface of the semiconductor laser element 22 and the other end links to the filter 26, and a second optical waveguide 29 in which one end is adapted to link to the optical fiber 5 which is to be fixed to the V groove 27 for mounting and fixing optical fiber and the other end is merged with the other end of the first optical waveguide 28 to thereby link to the filter 26. The first optical waveguide 28 and the second optical waveguide 29 are formed such that laser light, which propagates the first optical waveguide 28 and is reflected at the filter 26, links to the second optical waveguide 29. Further, the first optical waveguide 28 has the variable optical attenuator 25 mounted thereon. In the first exemplary embodiment, a Mach-Zehnder interferometer is provided as the variable optical attenuator 25 (hereinafter, referred to as the Mach-Zehnder interferometer 25).

The filter 26 is designed to reflect laser light from the semiconductor laser element 22 and to transmit laser light having a wavelength different from that of the laser light to be reflected, and is provided at a position where the first optical waveguide 28 and the second optical waveguide 29 are merged. The photodiode element 23 is arranged at an opposite position to the semiconductor laser element 22 with reference to the filter 26, and has a function of receiving an optical signal from the outside transmission path which has propagated the second optical waveguide 29 and passed through the filter 26.

The Mach-Zehnder interferometer 25 on the first optical waveguide 28 includes an optical waveguide 31 and an optical waveguide 32 as arm waveguides, and the optical waveguide 32 is equipped with a heater 33 for supplying heat to the waveguide 32. By providing an electrode to the heater 33 and wiring from the electrode to any one of the lead terminals 4A and 4B provided to the ceramic package 1 shown in FIG. 1, electric power can be supplied to the heater 33. With the electric power supplied to the heater 33, heat is generated.

In the Mach-Zehnder interferometer 25, the refractive index of the waveguide 32 varies corresponding to the heat of the heater 33, so a phase shift is caused in the propagated light on the waveguide 32. The propagated light from the waveguide 31 and the propagated light from the waveguide 32 are merged and superposed to thereby interfere each other. Due to the attenuation of the signal light intensity caused by the interference in the signal light, the optical output changes. Therefore, by manipulating the power supply to the heater 33, the optical output level of the optical transmitter-receiver can be regulated without limitation.

Hereinafter, operation of the first exemplary embodiment will be described.

First, a signal light from the semiconductor laser element 22 is linked to the first optical waveguide 28 to thereby propagate the first optical waveguide 28. The signal light propagated through the first optical waveguide 28 is divided at the input side of the Mach-Zehnder interferometer 25 into two directions of the waveguide 31 and the waveguide 32 and propagates the waveguides, and the divided pieces of light are merged on the emitting side and output. In this stage, when electric power is supplied to the heater 33, heat is generated, so the refractive index of the waveguide 32 changes due to the heat. Thereby, a phase shift is caused in the signal light, so that the pieces of light are interfered. Due to the attenuation of the signal light intensity caused by the interference in the signal light, the optical output level varies.

The signal light merged in the Mach-Zehnder interferometer 25 is fully reflected at the filter 26, propagates the second optical waveguide 29, and is transmitted to the outside transmission path through the optical fiber 5 shown in FIG. 2.

On the other hand, a signal light from the outside transmission path passes through the optical fiber 5 shown in FIG. 1 and then propagates the second optical waveguide 29, and is received by the photodiode element 23 via the filter 26.

As described above, in the optical transmitter-receiver of the first exemplary embodiment, it is possible to change the refractive index of the waveguide 32 in the Mach-Zehnder interferometer 25 provided in the optical transmitter-receiver module 2 by supplying electric power from the outside via any of the lead terminals 4A and 4B shown in FIG. 1, to thereby change the optical output level. Accordingly, the optical output level can be regulated without moving the semiconductor laser element 22, so the semiconductor laser element 22 is immune to damage. Therefore, regulation of the output light level can be set as a matter which is to be operated by a user.

According to the optical transmitter-receiver of the first exemplary embodiment configured as described above, the propagated light level is regulated by the variable optical attenuator 25 provided on the waveguide 28 even if the semiconductor laser element 22 oscillates a signal light of a high level which is beyond necessity. Therefore, leakage of oscillated light from the semiconductor laser element 22 to the photodiode element 23 is reduced.

Further, the light transmission distance can be varied without limitation by changing the optical output level, without changing the mounting position of the semiconductor laser element 22 or modifying the semiconductor laser element 22 itself which is a conventional method of regulating the optical output level. Moreover, since regulation of the output light level is performed inside the optical transmitter-receiver, the size of the optical transmitter-receiver will not be changed, so miniaturization can be realized.

Further, since intensity variation of light output from the semiconductor laser element 22 is absorbed by the variable optical attenuator, light having stable level can be transmitted irrespective of the quality of the semiconductor laser element 22. This improves the manufacturing yield.

Note that although, in the first exemplary embodiment, the output light level is regulated by providing the variable optical attenuator 25 on the waveguide 28, the present invention is not limited to this configuration. The variable optical attenuator may be provided on the waveguide 29. By providing the variable optical attenuator on the waveguide 29, the signal light received from the outside transmission path can be propagated while being regulated to have a level corresponding to the photodiode element 23.

Next, a second exemplary embodiment of the present invention will be described.

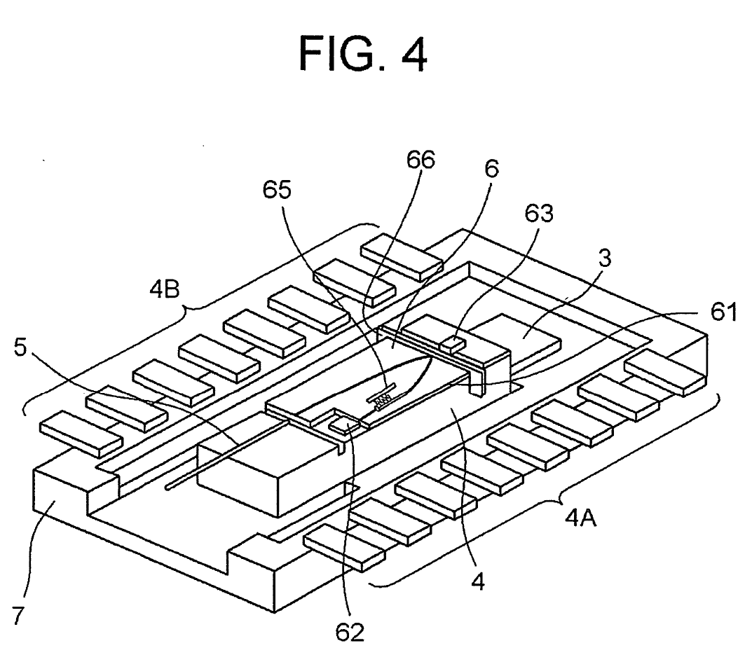

FIG. 4 illustrates the configuration of an optical transmitter-receiver according to the second exemplary embodiment. Note that the same components as those of the first exemplary embodiment shown in FIG. 1 are denoted by the same reference numerals.

As shown in FIG. 4, the optical transmitter-receiver of the second exemplary embodiment includes an optical transmitter-receiver module 6 and a transimpedance amplifier IC 3, in a ceramic package 7. The optical transmitter-receiver module 6 is configured such that a waveguide substrate 61 which forms a planar lightwave circuit, a semiconductor laser element 62, and a photodiode element 63 are integrated on a silicon substrate 64 (unit structure). The transimpedance amplifier IC 3 converts a current output from the photodiode element 63 of the optical transmitter-receiver module 6 into a voltage. The optical transmitter-receiver module 6 is equipped with an optical fiber 5.

The ceramic package 7 has a plurality of lead terminals 4A and 4B dividedly provided to the input side and the output side thereof. The lead terminals 4A and 4B are provided for electrically connecting the optical transmitter-receiver modules 6 and the transimpedance amplifier IC 3 inside the ceramic package 7 with a control circuit outside the package 7.

The optical transmitter-receiver module 6 according to the second exemplary embodiment is configured such that the waveguide substrate 61 which forms a planar lightwave circuit, the semiconductor laser element 62 serving as the laser oscillation element which oscillates laser light to be output to an outside transmission path through the planar lightwave circuit, and the photodiode element 63 serving as the light receiving element which receives laser light from the outside transmission path through the planar lightwave circuit, are integrated on the silicon substrate 64. On the planar lightwave circuit, a variable optical attenuator 65 is provided as a light intensity regulating device which regulates the light intensity of laser light propagating an optical waveguide.

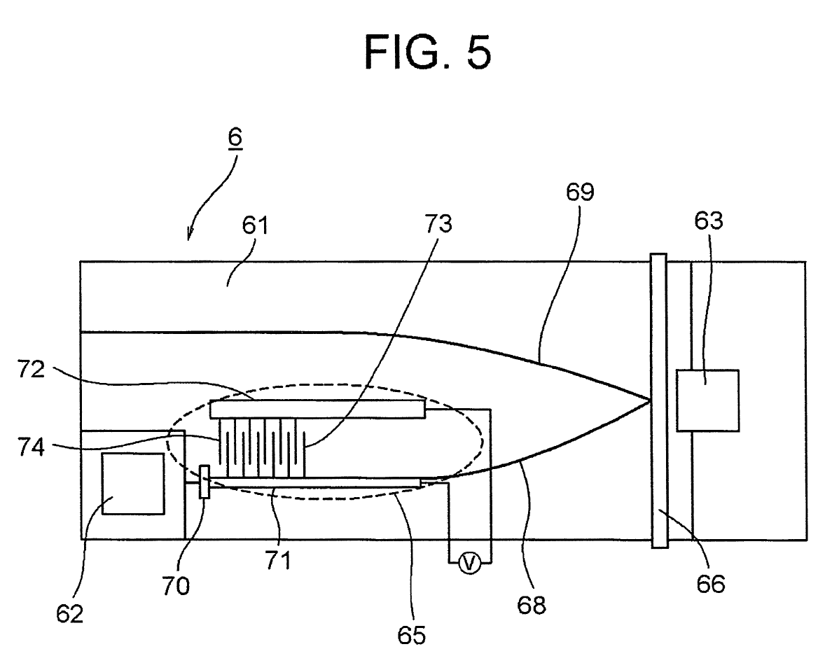

FIG. 5 illustrates the configuration of the optical transmitter-receiver module 6 according to the second exemplary embodiment.

As shown in FIG. 5, the optical transmitter-receiver module 6 of the second exemplary embodiment is configured such that, same as the configuration of the optical transmitter-receiver module 2 of the first exemplary embodiment shown in FIGS. 2 and 3, the waveguide substrate 61 which forms the planar lightwave circuit, the semiconductor laser element 62, a filter 66, and the photodiode element 63, are integrated on the silicon substrate 64, and a V groove 27 for mounting and fixing an optical fiber is formed in the silicon substrate 24.

Further, same as the first exemplary embodiment, the planar lightwave circuit formed on the waveguide substrate 61 includes a first optical waveguide 68 and a second optical waveguide 69. As a configuration different from that of the optical transmitter-receiver module 2 shown in FIGS. 2 and 3, an MEMS (Micro Electro Mechanical Systems) based variable optical attenuator 65 is provided on the first optical waveguide 68.

The MEMS-based variable optical attenuator 65 includes an optical shutter 70 which attenuates or shields laser light propagating the first optical waveguide 68, and a cantilever 71 and a fixing member 72 as a shutter drive for controlling open/close of the optical shutter 70.

The optical shutter 70 is mounted on the movable end of the cantilever 71. The cantilever 71 has a comb-shaped electrode 73 as a driven electrode, and the fixing member 72 also has a comb-shaped electrode 74 as a fixing electrode such that the comb-shaped electrode 74 is meshed with the comb-shaped electrode 73 of the cantilever 71.

By connecting the cantilever 71 and the fixing member 72 to any of the lead terminals 4A and 4B provided to the ceramic package 7 shown in FIG. 1 using wirings, a voltage can be applied between the cantilever 71 and the fixing member 72. By applying a voltage between the cantilever 71 and the fixing member 72, static electric power is generated between them.

Since the cantilever 71 and the fixing member 72 are provided with the comb-shaped electrode 73 and the comb-shaped electrode 74 respectively, the entire surface area of each of the cantilever 71 and the fixing member 72 becomes large. Therefore, the static electric power generated between the cantilever 71 and the fixing member 72 becomes large corresponding to the area, so there is no need to increase the voltage to be applied between the cantilever 71 and the fixing member 12.

Due to the attraction caused by the static electric power, the movable end part of the cantilever 71 is drawn to the fixing member 72 and deflected, whereby the optical shutter 70 moves to open and close the waveguide 68. As described above, by generating static electric power between the cantilever 71 and the fixing member 72 so as to drive the optical shutter 70 to open and close, the optical output level varies.

In the optical transmitter-receiver module 2 as described above, by changing the voltage to be applied between the cantilever 71 and the fixing member 72, the amount of light propagating the waveguide 68 can be regulated. Therefore, the optical transmitter-receiver according to the second exemplary embodiment is capable of regulating the optical output level without limitation.

In the optical transmitter-receiver of the second exemplary embodiment which is configured as described above, the optical output level can also be varied without limitation, so that the light transmission distance can be varied, without changing the mounting position of the semiconductor laser element 62 or modifying the semiconductor laser element 62 itself which is a conventional method of regulating the optical output level, same as that of the first exemplary embodiment. Moreover, since the output light level is regulated inside the optical transmitter-receiver, miniaturization can be realized without changing the size of the optical transmitter-receiver.

Next, other exemplary embodiments of the present invention will be described.

The optical transmitter-receiver module described above may be configured such that the planar lightwave circuit includes: a first optical waveguide linked to the laser oscillation element; and a second optical waveguide provided on the external input/output side, which is merged with and linked to the first optical waveguide at a filter part previously provided having a function of reflecting or dividing incident light into a transmission direction corresponding to the wavelength thereof, and the first optical waveguide includes a light intensity regulating device.

With this configuration, variation of light intensity output from the laser oscillation element can be absorbed by the light intensity regulating device. Therefore, light having a stable level can be transmitted regardless of the quality of the light emitting element, so manufacturing yield can be improved.

Further, the optical transmitter-receiver module described above may be configured such that the planar lightwave circuit includes: a first optical waveguide linked to the laser oscillation element; and a second optical waveguide provided on the external input/output side, which is merged with and linked to the first optical waveguide at a filter part previously provided having a function of reflecting or dividing incident light into a transmission direction corresponding to the wavelength thereof, and the second optical waveguide includes a light intensity regulating device.

With this configuration, the level of a signal light received from the outside transmission path can be regulated to a level corresponding to the light receiving element.

Further, in the optical transmitter-receiver module described above, the light intensity regulating device may by a variable optical attenuator which enables to control operation from the outside. With this configuration, the intensity level of light propagating the optical waveguide can be regulated within a certain range.

Further, in the optical transmitter-receiver module, the variable optical attenuator may be a Mach-Zehnder interferometer. With this configuration, no part moves physically, so light intensity can be regulated with high reliability.

Further, in the optical transmitter-receiver module, the variable optical attenuator may be an MEMS-based variable optical attenuator. With tins configuration, light intensity can be regulated with a simple structure.

Furthermore, in the optical transmitter-receiver module, the MEMS-based variable optical attenuator may be configured of an optical shutter which attenuates or shields propagating light in the light waveguide, and a shutter drive which drives the optical shutter to open and close. By changing the amount of light passing through the optical waveguide as described above, the intensity level of light propagating the optical waveguide can be regulated without limitation.

The optical transmitter-receiver according to the exemplary embodiments of the present invention is characterized in that the optical transmitter-receiver module described above is provided in the package, and the package is equipped with lead terminals for electrically connecting the light intensity regulating device of the optical transmitter-receiver module and a control circuit provided outside the package.

With such an optical transmitter-receiver, the intensity level of light propagating the optical waveguide of the optical transmitter-receiver module can be regulated without limitation according to the external manipulation, so transmission and reception of signal lights can be improved.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An optical transmitter-receiver module, comprising:
a laser oscillation element for oscillating laser light to be output to an outside through an optical waveguide for output;
a light receiving element for receiving laser light from the outside through an optical waveguide for input; and
a light intensity regulating device for regulating intensity of the laser light from the laser oscillation element, wherein
the laser oscillation element, the light receiving element and the light intensity regulating device are unitized.

2. The optical transmitter-receiver module, according to claim 1, wherein the optical waveguide for output and the optical waveguide for input are merged on the light receiving element side,
a filter is provided between a merged position of the optical waveguides and the light receiving element,
the filter reflects the laser light from the laser oscillation device towards the optical waveguide for output, and transmits the laser light from the optical waveguide for input to the light receiving element side, and
the light intensity regulating device is arranged on the optical waveguide for output which is provided between the laser oscillation element and the filter.

3. The optical transmitter-receiver module, according to claim 2, wherein the light intensity regulating device regulates light intensity by Interference caused in the laser light.

4. The optical transmitter-receiver module, according to claim 3, wherein the light intensity regulating device changes refractive index of the optical waveguide to thereby regulate the light intensity by interference caused due to a phase shift in the laser light.

5. The optical transmitter-receiver module, according to claim 4, wherein the light intensity regulating device changes the refractive index of the optical waveguide by adding heat.

6. The optical transmitter-receiver module, according to claim 5, wherein the light intensity regulating device is a Mach-Zehnder interferometer.

7. The optical transmitter-receiver module, according to claim 4, wherein the light intensity regulating device is an MEMS-based variable optical attenuator.

8. The optical transmitter-receiver module, according to claim 7, wherein the MEMS-based variable optical attenuator includes an optical shutter which attenuates or shields light propagating the optical waveguide, and a shutter drive which drives the optical shutter to open and close.

9. An optical transmitter-receiver module, comprising:
a laser oscillation element for oscillating laser light to be output to an outside through an optical waveguide for output;
a light receiving element for receiving laser light from the outside through an optical waveguide for input; and
a light intensity regulating means for regulating intensity of the laser light from the laser oscillation element, wherein
the laser oscillation element, the light receiving element and the light intensity regulating means are unitized.

10. An optical transmitter-receiver equipped with an optical transmitter-receiver nodule within a package, wherein
the optical transmitter-receiver modules includes:
a laser oscillation element for oscillating laser light to be output to an outside through an optical waveguide for output;
a light receiving element for receiving laser light from the outside through an optical waveguide for input; and
a light intensity regulating device for regulating intensity of the laser light from the laser oscillation element, wherein
the laser oscillation element, the light receiving element and the light intensity regulating device are unitized.

11. An optical transmitter-receiver equipped with an optical transmitter-receiver module within a package, wherein the optical transmitter-receiver modules includes:
a laser oscillation element for oscillating laser light to be output to an outside through an optical waveguide for output;
a light receiving element for receiving laser light from the outside through an optical waveguide for input; and
a light intensity regulating means for regulating intensity of the laser light from the laser oscillation element, wherein
the laser oscillation element, the light receiving element and the light intensity regulating means are unitized.
